(19) United States
(12) Patent Application Publication
(10) Pub. No.: US 2013/0340844 A1
(43) Pub. Date: Dec. 26, 2013

(54) ELECTROPNEUMATIC PILOT VALVE WITH HEAT SINK

(71) Applicant: ASCO JOUCOMATIC SA, Rueil Malmaison (FR)

(72) Inventors: Richard Vandamme, Cintray (FR); Michel Schmidt, Saint Maxime Hauterive (FR)

(21) Appl. No.: 13/925,140

(22) Filed: Jun. 24, 2013

(30) Foreign Application Priority Data
Jun. 25, 2012 (FR) 1256001

(51) Int. Cl. F16K 49/00

(52) U.S. Cl. CPC F16K 49/00
USPC 137/334

(57) ABSTRACT

A pneumatic distribution device includes at least one electromagnetic pilot valve and a distribution body. The device includes at least one heat sink having a thermal conductivity of at least 0.5 W/m K, tested in accordance with the ASTM D5470 standard. The heat sink is positioned between the at least one electromagnetic pilot valve and the distribution body.

### BACKGROUND OF THE INVENTION

1. Field of the Invention

This invention relates, generally, to pilot valves. More particularly, it relates to a novel heat sink for an electropneumatic pilot valve.

2. Description of the Prior Art

The power of compressed air used in actuating cylinders and motors needs to be controlled. A directional-control valve positioned between the source of pneumatic energy and the actuator performs this function.

Pneumatic directional-control valves generally require the use of electropneumatic pilot valves to allow them to switch states. These electropneumatic pilot valves are generally of the electromagnetic type and therefore generate heat associated with the Joule effect due to electric current passing through an inductor coil.

The heating effect can be reduced by limiting the power of the coil, but such power limitation impairs pneumatic performance. The electropneumatic pilot valves may also be positioned in such a way that their heat is transferred directly to the outside. This solution places severe restrictions on the pneumatic and electrical connections and therefore impacts the dimensioning of the pneumatic directional-control valve.

This disadvantage increases where pneumatic distribution blocks which are made up of several pneumatic directional-control valves are juxtaposed with one another. This juxtaposition, by confining the heat sources, further reduces the capacity for heat transfer to the outside, i.e., away from heat-sensitive devices.

The issue of heat transfer rates and improvement of same is a concern of electrical component manufacturers.

In the field of electric transformers, the solution put forward in patent JP2010027733 proposes accelerating the dissipation of heat using a simple metal plate and a thermal contact.

Unfortunately, such solutions provide an insufficient heat removal rate and therefore cannot guarantee optimum operation of the devices.

It is therefore an important object of the invention to optimize heat transfer from a pilot valve to an external medium.

However, in view of the prior art considered as a whole at the time of the invention, it was not obvious to those of ordinary skill how the heat transfer rate could be improved.

SUMMARY OF THE INVENTION

The novel pneumatic distribution device having at least one electromagnetic pilot valve and a distribution body includes at least one heat sink having a thermal conductivity of at least 0.9 W/m K, tested in accordance with the ASTM D5470 standard, positioned between said at least one electromagnetic pilot valve and said distribution body.

The novel pneumatic distribution device also includes a pneumatic distribution line associated with a sleeve and with a mobile spool with elastomeric sealing or so-called “metal-to-metal” sliding contact. A manual control device is optional as is a printed circuit connecting the pilots to the electric control circuits. Where a printed circuit is used, the heat sink allows greater proximity between the pilot and the electronic components of the circuit without the risk of the components of the circuit becoming damaged, due to the enhanced rate of heat transfer made possible by the novel heat sink.

A simple pneumatic base is also disclosed, in the case of a directional-control valve in isolation, or a juxtaposable pneumatic base in order to create a distribution block.

The use of one or more heat sinks able to collect and direct the thermal flux emitted thereby makes it possible to limit the extent to which the electromagnetic pilots heat up. It is also conceivable to combine these heat sinks in the assembly of the distribution body and of the pneumatic base, to further increase the capacity for heat transfer between these two parts.

Advantageously, the heat sink has a thermal conductivity of at least 0.9 W/m K, tested in accordance with the ASTM D5470 standard.

More advantageously, the heat sink has a thermal conductivity of at least 1.2 W/m K, tested in accordance with the ASTM D5470 standard.

The device may be assembled onto a metallic pneumatic base, at least one heat sink being interposed between the distribution body and the pneumatic base.

The heat sink may have a Shore 00 hardness between 30 and 80, tested in accordance with the ASTM D 2240 standard.

Advantageously, the heat sink has a Shore 00 hardness between 40 and 70, tested in accordance with the ASTM D 2240 standard.

More advantageously, the heat sink has a Shore 00 hardness between 40 and 50, tested in accordance with the ASTM D 2240 standard.

The heat sink may be obtained by polymerizing or solidifying a liquid or pasty material.

Other features and advantages of the invention will become apparent from the following description of a preferred embodiment (bistable directional-control valve with two electromagnetic pilots and juxtaposable pneumatic base) with reference to the attached drawings, but which does not imply any limitations.

### BRIEF DESCRIPTION OF THE DRAWINGS

FIG. 1 depicts a heat sink according to the invention mounted between the pilot and the distribution body.

FIG. 2 depicts the whole of the distribution body with the layout of the pilots and their respective heat sink and the heat sinks on the distribution body.

FIG. 3 depicts the distribution body mounted on the pneumatic base.

FIG. 4 depicts an embodiment in the form of a pneumatic distribution block.

### DETAILED DESCRIPTION OF THE PREFERRED EMBODIMENT

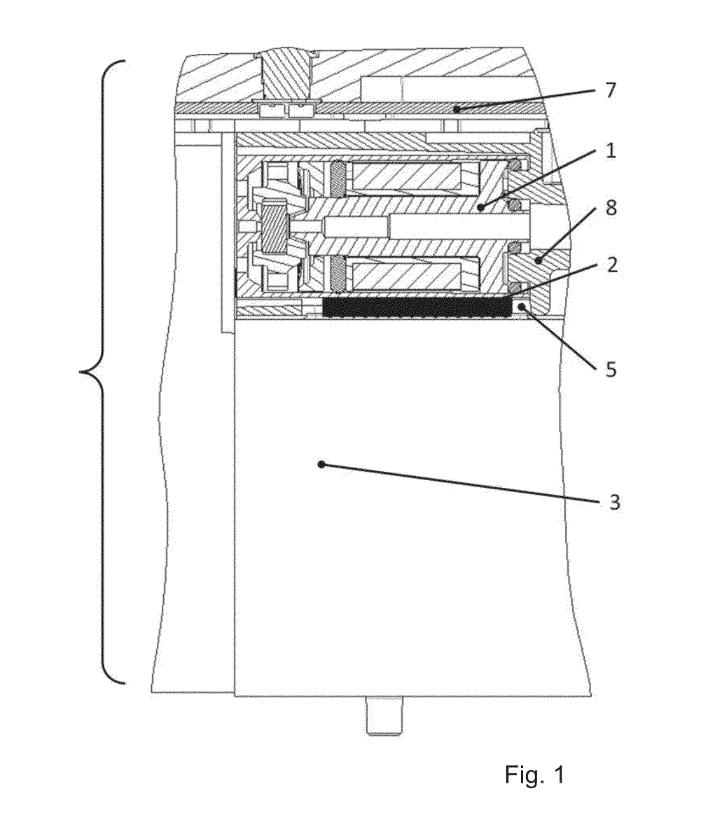

Heat sink 2, depicted in FIGS. 1 to 4, is made from a material of high thermal conductivity. It collects thermal flux and transfers it by conduction. Heat sink 2 is positioned between electropneumatic pilot 1 and metal body 3 of a pneumatic directional-control valve 4 of a device according to the invention. Heat sink 2 is housed in space 5 provided between electromagnetic pilot 1 and metal body 3 of pneumatic directional-control valve 4.

Heat sink 2 may be placed under stress to ensure permanent contact between the facing surfaces. Heat sink 2 may be made of an elastic or rigid material or may be made by polymerizing or solidifying a liquid or a pasty material.

Examples of heat sinks 2 include the 1000SF pads by Bergquist which have a thermal conductivity of 0.9 W/m K for a thickness of 0.254 to 3.175 mm, tested in accordance with the ASTM D5470 standard and a Shore 00 hardness of 40, tested in accordance with ASTM D 2240 standard, or the 575 NS pads by Parker which have a thermal conductivity of 1.2 W/m K for a thickness of 0.5 to 2.5 mm, tested in accordance with the ASTM D5470 standard and a Shore 00 hardness of 70, tested in accordance with the ASTM D 2240 standard.

There are numerous possible alternative ways of embodying the preferred embodiment disclosed hereinabove.

In an alternative embodiment, electropneumatic pilot 1 may be completely incorporated into the pneumatic directional-control valve 4 in housing 8 as depicted in FIG. 1. An additional electronic circuit 7 may be positioned near electropneumatic pilot 1, inside pneumatic directional-control valve 4.

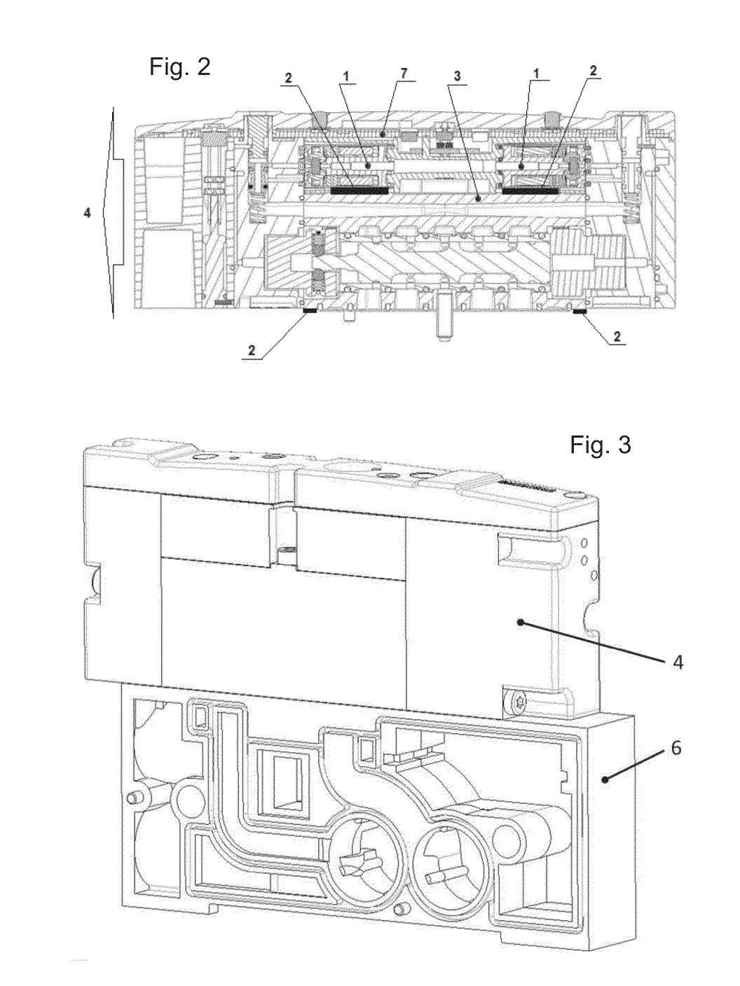

As depicted in FIG. 2, several electropneumatic pilots may be incorporated into one pneumatic directional-control valve 4.

Pneumatic directional-control valve 4 may also be assembled onto a metal base 6 as depicted in FIG. 3.

Several heat sinks may also advantageously be added to pneumatic directional-control valve 4 or to metal base 6, or both, or in between these two elements, to increase the conduction of the thermal flux and the dissipation of heat of the assembly of the pneumatic directional-control valve or valves 4 mounted on metallic base 6.

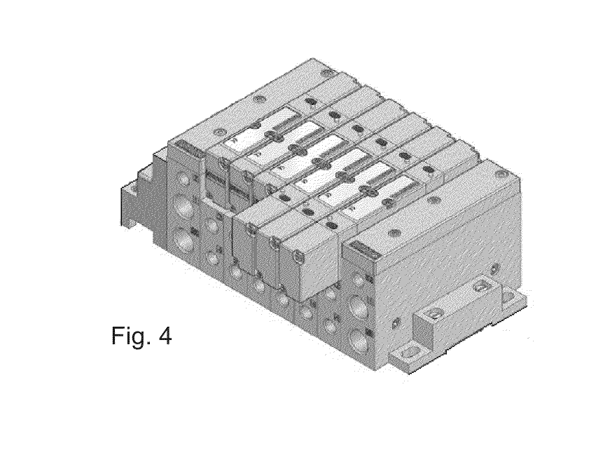

As indicated by FIGS. 2 and 3, it is possible to make use of the capacity for dissipation of heat which is associated with the flow of compressed air through the supply and return common lines of the base, and also to use the thermodynamic effects that come into play in the device, such as the cooling afforded by the expansion of the compressed air between the use and return orifices. The same principle applies to the distribution block embodiment of FIG. 4.

The device according to the invention makes it possible to increase the area for heat exchange with the external medium, but also the use of the pneumatic base and its circulation of compressed air flow such as, in particular, the supply and return common lines in the distribution blocks.

What is claimed is:

1. A pneumatic distribution device, comprising:
at least one electromagnetic pilot valve and a distribution body;
at least one heat sink having a thermal conductivity of at least 0.5 W/m K, tested in accordance with the ASTM D5470 standard, arranged between said at least one electromagnetic pilot valve and said distribution body.

2. The pneumatic distribution device of claim 1, further comprising:
said heat sink having a thermal conductivity of at least 0.9 W/m K, tested in accordance with the ASTM D5470 standard.

3. The pneumatic distribution device of claim 1, further comprising:
said heat sink having a thermal conductivity of at least 1.2 W/m K, tested in accordance with the ASTM D5470 standard.

4. The pneumatic distribution device of claim 1, further comprising:
a metallic pneumatic base;
said pneumatic distribution device being assembled onto said metallic pneumatic base; and
at least one heat sink being interposed between said distribution body and said metallic pneumatic base.

5. The pneumatic distribution device of claim 1, further comprising:
said heat sink having a Shore 00 hardness between 30 and 80, tested in accordance with the ASTM D 2240 standard.

6. The pneumatic distribution device of claim 4, further comprising:
said heat sink having a Shore 00 hardness between 30 and 80, tested in accordance with the ASTM D 2240 standard.

7. The pneumatic distribution device of claim 1, further comprising:
said heat sink having a Shore 00 hardness between 40 and 70, tested in accordance with the ASTM D 2240 standard.

8. The pneumatic distribution device of claim 4, further comprising:
said heat sink having a Shore 00 hardness between 40 and 70, tested in accordance with the ASTM D 2240 standard.

9. The pneumatic distribution device of claim 1, further comprising:
said heat sink having a Shore 00 hardness between 40 and 50, tested in accordance with the ASTM D 2240 standard.

10. The pneumatic distribution device of claim 4, further comprising:
said heat sink having a Shore 00 hardness between 40 and 50, tested in accordance with the ASTM D 2240 standard.

11. The pneumatic distribution device of claim 1, further comprising:
said heat sink obtained by polymerizing a liquid material.

12. The pneumatic distribution device of claim 1, further comprising:
said heat sink obtained by polymerizing a pasty material.

13. The pneumatic distribution device of claim 1, further comprising:
said heat sink obtained by solidifying a liquid material.

14. The pneumatic distribution device of claim 1, further comprising:
said heat sink obtained by solidifying a pasty material.

15. The pneumatic distribution device of claim 4, further comprising:
said heat sink obtained by polymerizing a liquid material.

16. The pneumatic distribution device of claim 4, further comprising:
said heat sink obtained by polymerizing a pasty material.

17. The pneumatic distribution device of claim 4, further comprising:
said heat sink obtained by solidifying a liquid material.

18. The pneumatic distribution device of claim 4, further comprising:
said heat sink obtained by solidifying a pasty material.

19. The pneumatic distribution device of claim 1, further comprising:
said at least one pilot valve being built into said distribution body.

20. The pneumatic distribution device of claim 4, further comprising:
said at least one pilot valve being built into said distribution body.
